(19) United States
(12) Patent Application Publication
(10) Pub. No.: US 2011/0043635 A1
(43) Pub. Date: Feb. 24, 2011

(54) VEHICLE DRIVING EVALUATION APPARATUS AND METHOD, AND COMPUTER PROGRAM

(76) Inventors: Ryujiro Fujita, Kawasaki (JP); Kohei Ito, Kawagoe (JP)

Correspondence Address: NIXON & VANDERHYE, PC, 901 NORTH GLEBE ROAD, 11TH FLOOR, ARLINGTON, VA, 22203, US

(21) Appl. No.: 12/919,352

(22) PCT Filed: Feb. 28, 2008
(86) PCT No.: PCT/JP2008/053488

§ 371 Date: Oct. 19, 2010

(51) Int. Cl. G06K 9/00; H04N 7/18

(52) U.S. Cl. 348/149; 382/104; 348/E07.085

(57) ABSTRACT

A vehicle driving evaluation apparatus (1) is provided with: a behavior detecting device (101) for detecting a behavior of a vehicle a driver is driving; a driving analyzing device (103) for analyzing an aspect of driving of the driver on the basis of the behavior of the vehicle; a road analyzing device (106) for analyzing condition of a road on which the vehicle travels; and a travel situation evaluating device (107) for evaluating a travel situation of the vehicle on the basis of the aspect of the driving of the driver and the conditions of the road on which the vehicle travels.

### TECHNICAL FIELD

The present invention relates to a vehicle driving evaluation apparatus for evaluating the driving of a driver of a vehicle in a car navigation system, a robot mounted on the vehicle, or the like.

### BACKGROUND ART

A vehicle such as an automobile uses a vehicle driving evaluation apparatus for evaluating a driver's driving on the basis of vehicle travel information detected by various sensors. As such a vehicle driving evaluation apparatus, for example, a patent document 1 discloses that a driving situation by the driver of the vehicle based on the detected vehicle information is calculated and that, under the assumption that the vehicle has a predetermined personality, it is expressed by a virtual emotion of the personality according to the driving situation.

Moreover, a patent document 2 discloses a technology in which an image obtained by an image obtaining device, such as a camera, is analyzed to judge information about the content of the image, such as an object and landscape included in the image.

Patent document 1: Japanese Patent Application Laid Open No 2003-72488
Patent document 2: International Publication WO2007/000999

### DISCLOSURE OF INVENTION

### Subject to be Solved by the Invention

According to the construction described in the patent document 1, the vehicle travel information based on information about a vehicle behavior and a vehicle operation by the driver's driving is outputted by the virtual emotion through a character's expression, by which it is possible to provide entertainment for a vehicle occupant while preferably evaluating the vehicle travel situation.

However, according to such construction, for example, it is hardly possible to evaluate the driving based on information about the outside of the vehicle, such as conditions of a road on which the vehicle travels. In other words, even if the vehicle is in motion under the same conditions of the driver's driving, the vehicle behavior, or the like, it is desirable to preferably change the evaluation for the travel situation in accordance with the conditions of the road on which the vehicle travels, such as a general road, an expressway, or an alley in a crowded residential area.

In view of the aforementioned problems, it is therefore an object of the present invention to provide a vehicle driving evaluation apparatus for performing driving evaluation based on information about a vehicle operation by a driver and information about a road on which a vehicle is in motion and for announcing an evaluation result.

### Means for Solving the Object

The above object of the present invention can be achieved by a vehicle driving evaluation apparatus provided with: a behavior detecting device for detecting a behavior of a vehicle a driver is driving; a driving analyzing device for analyzing an aspect of driving of the driver on the basis of the behavior of the vehicle; a road analyzing device for analyzing condition of a road on which the vehicle travels; and a travel situation evaluating device for evaluating a travel situation of the vehicle on the basis of the aspect of the driving of the driver and the conditions of the road on which the vehicle travels.

The above object of the present invention can be also achieved by a computer program for controlling a computer provided in a vehicle driving evaluation apparatus provided with: a behavior detecting device for detecting a behavior of a vehicle a driver is driving; a driving analyzing device for analyzing an aspect of driving of the driver on the basis of the behavior of the vehicle; a road analyzing device for analyzing condition of a road on which the vehicle travels; and a travel situation evaluating device for evaluating a travel situation of the vehicle on the basis of the aspect of the driving of the driver and the conditions of the road on which the vehicle travels, the computer program making the computer function as at least one portion of the behavior detecting device, the driving analyzing device, the road analyzing device, and the travel situation evaluating device.

The above object of the present invention can be also achieved by a vehicle driving evaluation method provided with: a behavior detecting process of detecting a behavior of a vehicle a driver is driving; a driving analyzing process of analyzing an aspect of driving of the driver on the basis of the behavior of the vehicle; a road analyzing process of analyzing condition of a road on which the vehicle travels; and a travel situation evaluating process of evaluating a travel situation of the vehicle on the basis of the aspect of the driving of the driver and the conditions of the road on which the vehicle travels.

### BRIEF DESCRIPTION OF DRAWINGS

FIG. 1 is a block diagram conceptually showing the basic structure of a vehicle driving evaluation apparatus of an embodiment.

FIG. 2 is a flowchart showing a flow of the basic operations of the vehicle driving evaluation apparatus of the embodiment.

FIG. 3 is a graph example showing an aspect of operation of a driver's driving safety of the embodiment.

FIG. 4 is a graph example showing an aspect of operation of a road complexity degree around the vehicle in motion of the embodiment.

FIG. 5 is one example of a graph showing correspondence between evaluation for a vehicle travel situation and an emotion of a virtual personality of the embodiment.

FIG. 6 is a graph example showing an aspect of operation of the emotion of the virtual personality which accompanies the evaluation for the vehicle travel situation of the embodiment.

FIG. 7 is another example of the graph showing the correspondence between the evaluation for the vehicle travel situation and the emotion of the virtual personality of the embodiment.

FIG. 8 is a flowchart conceptually showing a flow of the basic operations associated with the evaluation for the vehicle travel situation by the driving evaluation apparatus of the embodiment.

FIG. 9 is a block diagram conceptually showing the basic structure of a vehicle driving evaluation apparatus of an alternative embodiment.

### DESCRIPTION OF REFERENCE CODES

1 vehicle driving evaluation apparatus
101 acceleration sensor
102 sensor input part
103 driving analysis part
104 camera
105 image analysis part
106 road analysis part
107 travel situation operation part
108 information output part
109 information recording part
110 map information obtaining part

### BEST MODE FOR CARRYING OUT THE INVENTION

Hereinafter, as the best mode for carrying out the invention, embodiments of the vehicle driving evaluation apparatus and method, and the computer program of the present invention will be explained.

An embodiment of the vehicle driving evaluation apparatus of the present invention is provided with: a behavior detecting device for detecting a behavior of a vehicle a driver is driving; a driving analyzing device for analyzing an aspect of driving of the driver on the basis of the behavior of the vehicle; a road analyzing device for analyzing condition of a road on which the vehicle travels; and a travel situation evaluating device for evaluating a travel situation of the vehicle on the basis of the aspect of the driving of the driver and the conditions of the road on which the vehicle travels.

According to the vehicle driving evaluation apparatus of the present invention, in the vehicle driven by the driver, it is possible to evaluate the vehicle travel situation on the basis of information indicating the aspect of the driving of the driver (e.g. driving safety) and information indicating the conditions of the road on which the vehicle travels.

The aspect of the driving of the driver in the embodiment is typically the evaluation result of the driver's driving safety based on the behavior of the vehicle, such as a change in the acceleration, and it can be the index of the driver's driving safety based on operations, such as sudden acceleration, sudden braking, and sudden steering by the driver. The road conditions in the embodiment indicate at least the conditions of the road around the vehicle in motion, such as complexity of scenery of a road detailed later.

In the embodiment, the driver's driving safety is analyzed by the driving analyzing device on the basis of information indicating the vehicle behavior always obtained by the behavior detecting device. The aspect of the analysis of the safety by the driving analyzing device can be performed by an addition/subtraction process for some numerical value defined as a driving safety degree as detailed later. In this aspect, typically, a numerical value indicating a predetermined driving safety degree is added or subtracted in timing in which a behavior judged to be dangerous driving (or judged to be safe driving) is detected in the always detected vehicle behavior. By observing the numerical value indicating the driving safety degree as time-series data, it is possible to analyze the driver's driving safety as time advances. Moreover, the aspect of the analysis of the driving safety is not always limited to this aspect and may be an arbitrary aspect in which it is possible to obtain the index that can preferably indicate the driver's driving safety in some ways, and more preferably in which it is possible to analyze the driving safety as time advances.

Moreover, in the embodiment, the index that can preferably indicate the conditions of the road on which the vehicle travels is analyzed by the road analyzing device, more preferably, all the time in motion. Such an aspect of the analysis of the road conditions is performed by an addition/subtraction process for some numerical value which is the index that can indicate a complexity degree of the road or the like, as detailed later.

On the basis of the condition of the road on which the vehicle travels and the aspect of the driving of the driver of the vehicle analyzed in the above manner, the travel situation evaluating device evaluates the vehicle travel situation. The aspect of the evaluation for the travel situation is preferably performed on the basis of the information caused by the driver's driving and the information caused by the conditions of the road on which the vehicle travels. The aspect can be, but not limited to, an evaluation method using a two-axis graph detailed later as one example, and it may be an arbitrary aspect in which evaluation based on the both information can be performed in some ways.

By this, it is possible to evaluate the vehicle travel situation in consideration of not only the aspect of the driver's driving (in other words, information closed within the vehicle) but also the conditions of the road on which the vehicle is driving (in other words, information about the outside of the vehicle). For example, even if the evaluation is “relatively dangerous” according only to the driving situation, the evaluation result can be further changed in various ways in accordance with whether the situation of the external world is an open expressway or a narrow, crowded road such as a shopping district. Therefore, the travel situation can be evaluated in association with the outside (or external world) of the vehicle. In other words, it is possible to perform the evaluation according to the travel situation more accurately or in more various, in consideration of not only the aspect of the driving of the driver (in other words, information closed within the vehicle) but also the conditions of the road on which the vehicle is driving (in other words, information about the outside of the vehicle).

Incidentally, the vehicle driving evaluation apparatus in the embodiment is typically a so-called stand-alone apparatus which is installed or placed in the vehicle in order to operate alone, and it is provided with the behavior detecting device, the road analyzing device, the driving analyzing device, and the travel situation evaluating device. On the other hand, however, the vehicle driving evaluation apparatus may be built in an apparatus such as a digital tacograph and a car navigation system, or the vehicle itself, and it may be also constructed in an aspect of a so-called built-in type with respect to another apparatus, in which the vehicle driving evaluation apparatus analyzes the vehicle behavior in response to an input from the behavior detecting device which is provided for the apparatus and which can preferably detect the vehicle behavior.

In one aspect of the vehicle driving evaluation apparatus of the present invention, the travel situation evaluating device classifies the travel situation of the vehicle into a plurality of ways for the evaluation, on the basis of at least two-axis graph information with each of the aspect of the driving of the driver and the conditions of the road on which the vehicle travels on the axis.

According to this aspect, in view of an element caused by the aspect of the driving of the driver of the vehicle and an element caused by the aspect of the road on which the vehicle travels, it is possible to preferably evaluate the vehicle travel situation based on the both elements. In such an aspect of the evaluation, typically, in the graph having coordinates where the conditions of the road on which the vehicle travels and the driver's driving safety cross at each other, if the coordinates indicated by the operated road conditions and the operated driving safety are in a predetermined area, then, the evaluation is performed in accordance with the predetermined area.

Here, the “predetermined area” is an area on the aforementioned two-axis graph divided by the coordinates of the driving safety and the road conditions (or some numerical value), and more preferably, it is provided in a plurality of ways. For each “predetermined area”, respective one of a plurality of evaluation results is correspondingly provided. If the coordinates of the driving safety and the road conditions are in the predetermined area, the corresponding evaluation result may be read.

By virtue of such construction, by applying the aforementioned two-axis graph to the driver's driving safety and the conditions of the road on which the vehicle travels detected in the above manner, it is possible to preferably evaluate the vehicle travel situation without requiring complicated operation.

In another aspect of the vehicle driving evaluation apparatus of the present invention, the driving analyzing device analyzes a driving safety degree as a parameter based on the aspect of the driving, and the road analyzing device analyzes a complexity degree of the road as the conditions of the road on which the vehicle travels.

Here, the driving safety degree is, as described above, the index for preferably evaluating the aspect of the driving of the driver. Typically, while the acceleration of the vehicle is always monitored, if the acceleration greater than or equal to a predetermined value is detected, the driving is judged to be dangerous driving, and if the driving judged to be the dangerous driving is not detected, then, it is judged to be safe driving. At this time, by virtue of the construction that the value of the numerical value which is the index (i.e. the driving safety degree) is subtracted every time the dangerous driving is detected and that the driving safety degree is gradually added every time the safe driving is detected (i.e. if the dangerous driving is not detected in a predetermined period), it is possible to evaluate the current driver's driving from the driving safety degree. At the same time, by obtaining the transition of the driving safety degree, it is also possible to preferably evaluate the driver's driving tendency as time advances. Moreover, the aspect of the analysis of the driving safety degree is not particularly limited to this aspect and may be an arbitrary aspect in which it is possible to obtain the index that can preferably indicate the driver's driving safety in some ways and more preferably in which it is possible to analyze the driving safety as time advances.

Here, the complexity degree of the road is the degree or extent of the complexity (or simpleness or monotony) of the road scenery, caused by that the road on which the vehicle travels is a road in an urban area, a forest road, or an open road such as an expressway. For example, in a road with a high complexity degree (i.e. a road in which the scenery outside the vehicle is complicated, such as a street and a forest road), it is considered that a vehicle occupant tends to be interested in the scenery outside the vehicle. In a road with a low complexity degree, it is considered that the vehicle occupant focuses on a conversation and driving inside the vehicle rather than outside the vehicle.

Moreover, as a factor for determining the complexity degree of the road, such an analysis that considers an obstacle for the vehicle to travel, such as a vehicle around and comings and goings of people, or the complexity of a road slope and a road shape, or the like may be performed.

The aspect of the analysis of the complexity degree of the road by the road analyzing device can be performed by an addition/subtraction process for some numerical value defined as a road complexity degree. In this aspect, typically, a numerical value indicating a certain road complexity degree is added or subtracted in timing in which a road condition judged to be complicated (or judged to be simple) is detected in some information detected constantly indicating the behavior and the conditions of the road on which the vehicle travels. By observing the numerical value indicating the road complexity degree as time-series data, it is possible to analyze the complexity degree of the road on which the vehicle travels as time advances. Moreover, the aspect of the analysis of the complexity degree of the road is not always limited to this aspect and may be an arbitrary aspect in which it is possible to obtain the index that can preferably indicate the complexity degree of the road in some ways, and more preferably in which it is possible to obtain the road complexity degree as time advances.

The aspect of the judgment of the complexity degree, as detailed later, may be performed by the obtainment and analysis of the image of the scenery outside the vehicle, or by the obtainment and analysis of map information.

By analyzing the complexity degree of the road scenery and adding it to the basis for the decision of the evaluation for the travel situation, it is possible to preferably estimate the mind of the occupant including the driver of the vehicle, and it is possible to perform preferable evaluation in such construction that the evaluation result of the travel situation detailed later is outputted by adopting the aspect of the emotion of a virtual personality set correspondingly to the evaluation result.

Moreover, in an aspect of the vehicle driving evaluation apparatus of the present invention, it is further provided with an outputting device for performing an output based on an evaluation result of the travel situation of the vehicle.

By virtue of such construction, it is possible to preferably announce the evaluation result of the travel situation based on the driver's driving safety and the conditions of the road on which the vehicle travels, as performed above, to the vehicle occupant including the driver. The aspect of the announcement is preferably performed by character, text, image or video output via a display, audio output via a speaker, or the like. However, it is not always limited to this aspect and may be an arbitrary aspect in which the announcement based on the evaluation result described above can be performed to the occupant to some extent in some ways.

Moreover, in this aspect, each of a plurality of types of emotions owned by a virtual personality may be assigned in association with respective one of the travel situations classified in the plurality of ways, and the outputting device outputs at least one emotion from the plurality of emotions.

By virtue of such construction, the announcement to the vehicle occupant based on the evaluation result described above is performed in a form of the expression of emotions which is estimated to be felt by the virtual personality or which is calculated in that manner, in accordance with the evaluation result of the travel situation. Here, the “virtual personality” indicates, in effect, the subject that can change the emotion according to at least the travel situation of the vehicle (i.e. the driver's driving safety and the conditions of the road on which the vehicle travels) based on the assumption that the vehicle has a personality, or that the vehicle occupant has the personality, or the like. The “emotion” of the virtual personality is operated in accordance with the travel situation: for example, a good feeling for the driver's safe driving, and hate or fear for the dangerous driving. According to such construction, in the announcement of the evaluation for the vehicle travel situation, can be entertaining, and more effective announcement can be realized.

Such an “emotion of the virtual personality” may be outputted by the operation of a character which is displayed on a display and which responds to the emotion, by audio announce via a speaker, or by the operation of a robot. According to such construction, in the announcement of the evaluation for the vehicle travel situation, can be more entertaining, and more effective announcement can be realized.

On the other hand, by announcing the evaluation result to the vehicle driver, it is possible to announce the emotion for the travel situation which is estimated to be felt by another vehicle occupant, to the driver. It is also possible to preferably provide an opportunity for the driver to change and improve the aspect of the driving in accordance with the announcement.

In another aspect of the vehicle driving evaluation apparatus of the present invention, the vehicle driving evaluation apparatus is further provided with an image obtaining device for obtaining an image of scenery around the vehicle, and the road analyzing device analyzes a complexity degree of the road as the conditions of the road on which the vehicle travels, on the basis of the image of the scenery around the vehicle.

According to this aspect, it is possible to analyze the complexity degree associated with the aspect of the travel on the road, from the image of the scenery outside the vehicle obtained by the image obtaining device. Moreover, it may be constructed such that information about an obstacle for the vehicle to travel, such as a vehicle around and comings and goings of people, from the image of the scenery outside the vehicle, as well as analyzing the complexity degree.

The aspect of the analysis of the complexity degree of the road from the image of the scenery outside the vehicle is performed by dividing the obtained image into a plurality of image pieces and by performing a color analysis process, a fractal dimension analysis process, and an artifact amount recognition process on each image piece, as described in the patent document 2. By a combination of the analysis results obtained in the above processes, a landscape included in each image piece is classified, and on this classification result, the features of the landscape included in each image piece are judged.

By virtue of such construction, it is possible to preferably analyze the complex road of the road on which the vehicle travels, by always obtaining and analyzing the image of the outside of the vehicle from the vehicle in motion.

In another aspect of the vehicle driving evaluation apparatus of the present invention, the vehicle driving evaluation apparatus is further provided with a map information obtaining device for obtaining at least map information around the vehicle, and the road analyzing device analyzes a complexity degree of the road as the conditions of the road on which the vehicle travels, on the basis of the map information around the vehicle.

According to this aspect, by analyzing the map information including the road on which the vehicle travels, it is possible to analyze the complexity degree associated with the aspect of the travel on the road. Here, the map information is more preferably provided with road shape information, slope information, and surrounding scenery information, and it may be in an arbitrary aspect if the complexity degree of the road can be preferably obtained, as described above, by analyzing at least the map information.

An embodiment of the computer program of the present invention is a computer program for controlling a computer provided in a vehicle driving evaluation apparatus provided with: a behavior detecting device for detecting a behavior of a vehicle a driver is driving; a driving analyzing device for analyzing an aspect of driving of the driver on the basis of the behavior of the vehicle; a road analyzing device for analyzing condition of a road on which the vehicle travels; and a travel situation evaluating device for evaluating a travel situation of the vehicle on the basis of the aspect of the driving of the driver and the conditions of the road on which the vehicle travels, the computer program making the computer function as at least one portion of the behavior detecting device, the driving analyzing device, the road analyzing device, and the travel situation evaluating device.

According to the embodiment of the computer program of the present invention, the aforementioned embodiment of the vehicle driving evaluation apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the embodiment of the vehicle driving evaluation apparatus of the present invention, the embodiment of the computer program of the present invention can also adopt various aspects.

An embodiment of the computer program product of the present invention is a computer program product in a computer-readable medium for tangibly embodying a program of instructions executable by a computer provided in a vehicle driving evaluation apparatus provided with: a behavior detecting device for detecting a behavior of a vehicle a driver is driving; a driving analyzing device for analyzing an aspect of driving of the driver on the basis of the behavior of the vehicle; a road analyzing device for analyzing condition of a road on which the vehicle travels; and a travel situation evaluating device for evaluating a travel situation of the vehicle on the basis of the aspect of the driving of the driver and the conditions of the road on which the vehicle travels, the computer program product making the computer function as at least one portion of the behavior detecting device, the driving analyzing device, the road analyzing device, and the travel situation evaluating device.

According to the embodiment of the computer program product of the present invention, the aforementioned embodiment of the vehicle driving evaluation apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned embodiment of the vehicle driving evaluation apparatus of the present invention.

Incidentally, in response to the various aspects of the embodiment of the vehicle driving evaluation apparatus of the present invention, the embodiment of the computer program product of the present invention can also adopt various aspects.

An embodiment of the vehicle driving evaluation method of the present invention is provided with: a behavior detecting process of detecting a behavior of a vehicle a driver is driving; a driving analyzing process of analyzing an aspect of driving of the driver on the basis of the behavior of the vehicle; a road analyzing process of analyzing condition of a road on which the vehicle travels; and a travel situation evaluating process of evaluating a travel situation of the vehicle on the basis of the aspect of the driving of the driver and the conditions of the road on which the vehicle travels.

According to the vehicle driving evaluation method of the present invention, as in the aforementioned vehicle driving evaluation apparatus of the present invention, it is possible to evaluate the vehicle travel situation of the vehicle driven by the driver, on the basis of the information indicating the aspect of the driving of the driver and the information indicating the conditions of the road on which the vehicle travels.

Incidentally, even the vehicle driving evaluation method of the present invention can adopt the same various aspects as those of the vehicle driving evaluation apparatus of the present invention described above.

As explained above, the vehicle driving evaluation apparatus in the embodiment is provided with the behavior detecting device, the road analyzing device, the driving analyzing device, and the travel situation evaluating device. The vehicle driving evaluation method in the embodiment is provided with the behavior detecting process, the road analyzing process, the driving analyzing process, and the travel situation evaluating process. The computer program in the embodiment makes a computer function as the vehicle driving evaluation apparatus in the embodiment. Therefore, it is possible to evaluate the travel situation of the vehicle by the driver's driving by using the information about the road on which the vehicle travels and the information about the vehicle behavior, and it is possible to announce the evaluation result to the driver and occupant of the vehicle.

### EXAMPLE

Hereinafter, a preferred example of the present invention will be explained with reference to the drawings.

### (1) Structure Example

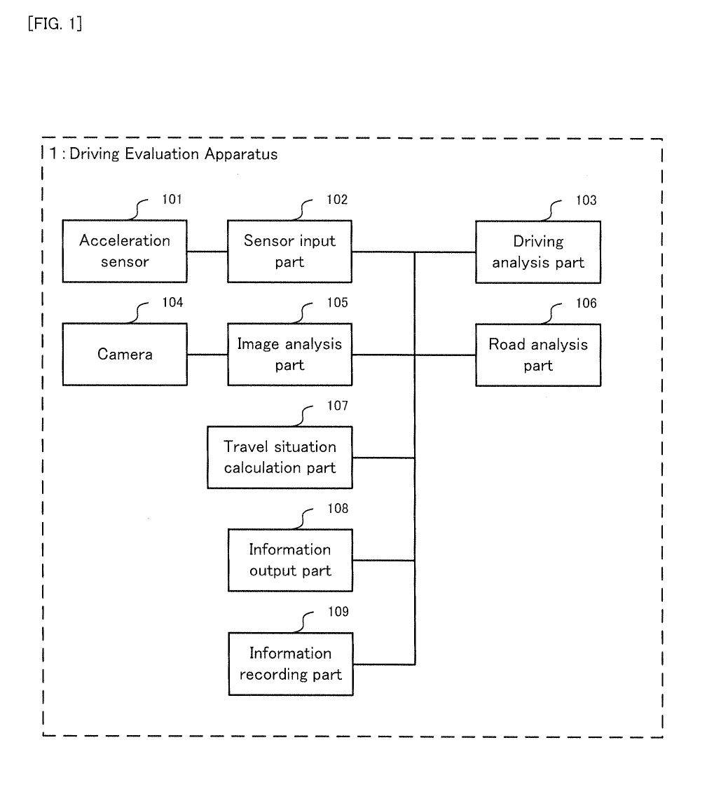

A structure example of a vehicle driving evaluation apparatus in an example of the present invention will be explained with reference to FIG. 1 to FIG. 6. FIG. 1 is a block diagram conceptually showing the basic structure of the vehicle driving evaluation apparatus in the example.

As shown in FIG. 1, a driving evaluation apparatus 1 in the example is provided with an acceleration sensor1 101, a sensor input part 102, a driving analysis part 103, a camera 104, an image analysis part 105, a road analysis part 106, a travel situation operation part 107, an information output part 108, and an information recording part 109. Incidentally, the camera 104 may be built or incorporated in the driving evaluation apparatus 1 in an integrated manner, or it may be separate from the driving evaluation apparatus 1. In this case, an image taken by the camera 104 is transmitted to the image analysis part 107 through some device, such as a wired or wireless device.

The acceleration sensor 101 is one specific example of the “behavior detecting device” in the structure example of the present invention. The acceleration sensor 101 can detect the acceleration of a not-illustrated vehicle on which the driving evaluation apparatus 1 is mounted and can output it to the sensor input part 102, and the acceleration sensor 101 is provided, for example, with a triaxial acceleration sensor. More specifically, at least the accelerations in a longitudinal direction and in a lateral or vertical direction of the vehicle detected on the acceleration sensor 101 are treated as time-series data of the vehicle acceleration on the sensor input part 102, so that it is held for a predetermined time. Alternatively, the acceleration data is stored in the information recording part 109 described later.

The driving analysis part 103 is one specific example of the “driving analyzing device” in the structure example of the present invention. The driving analysis part 103 numerically analyzes a driver's driving safety as a driving safety degree, in the time-series data of the acceleration held. More specifically, the driving analysis part 103 judges that the acceleration that exceeds a predetermined threshold value is caused by “dangerous driving”. For example, as the threshold value of the acceleration judged to be the “dangerous driving”, the following accelerations are set: a forward acceleration of 0.4 G of the vehicle in sudden acceleration; a backward acceleration of 0.2 G of the vehicle in sudden braking; and a lateral acceleration of 0.5 G of the vehicle in sudden steering. Then, in the time-series data of the acceleration always detected, the value of the driving safety degree is increased or reduced on the basis of the driving judgment.

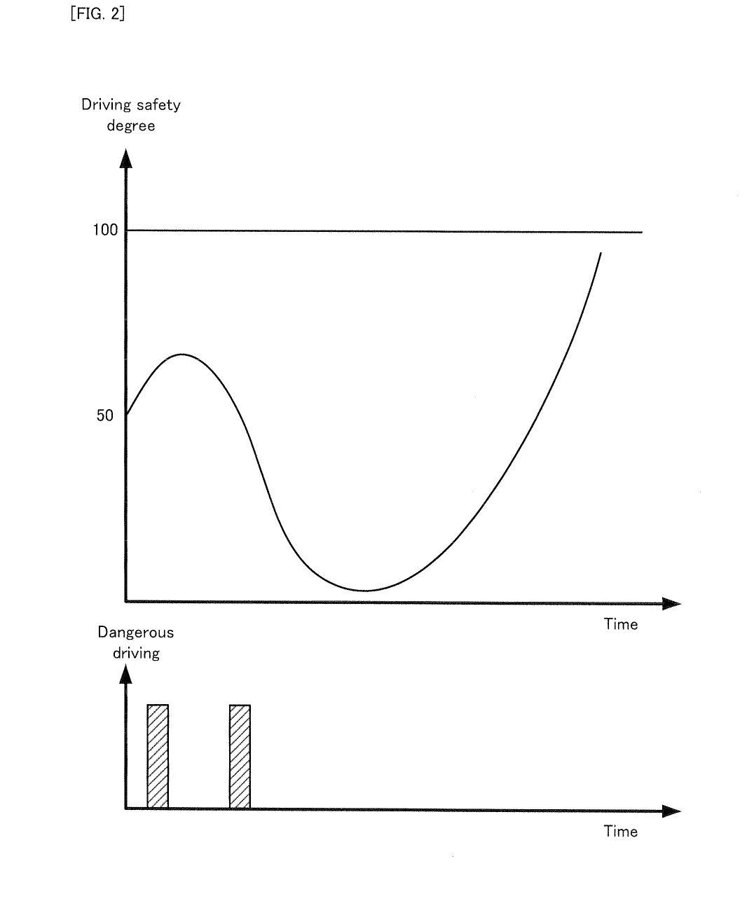

Here, FIG. 2 is a graph showing the value of the driving safety degree operated on the driving analysis part 103, showing one example of the time-series data of the driving safety degree AN starting from AN=50, wherein the horizontal axis indicates time and the vertical axis indicates the driving safety degree AN. At this time, the driving safety degree AN is expressed as AN=A(N−1)+K(N>0), wherein N is a time-series data number indicating the order of the time series in the time-series data. The range of the driving safety degree AN is set to be 0 to 100, and a value remains within the range when it goes out of the range (e.g. 0 is set as the lower limit and 100 as the upper limit). At this time, as the driving safety degree AN gets closer to 0, the driver's driving is judged to be more dangerous, and as the driving safety degree AN gets closer to 100, the driver's driving is judged to be safer. Here, K is a predetermined numerical value defined as a driving danger index, and the K value is reduced (e.g. K−2) when the judgment is the aforementioned “dangerous driving”. On the other hand, the K value is added (e.g. K+0.1) when the judgment is not the “dangerous driving” for a predetermined time. Moreover, if K<−20, K=−20 is set as the lower limit, and if K>1, K=1 is set as the upper limit.

As shown in FIG. 2, the driver's driving starting from the driving safety degree AN=50 continues safe driving at the beginning, and the graph rises moderately. Then, it starts to decrease at a time point at which the dangerous driving (e.g. sudden braking) is performed, and the repetition of such dangerous driving increases the slope of the decrease. Since the dangerous driving is not performed for a predetermined time when the driving safety degree AN gets close to 0, the K value is gradually added, and the value of the driving safety degree AN also starts to increase. Incidentally, in the lower part of FIG. 2, timing judged to be the “dangerous driving” in the detection of the acceleration is shown by a bar graph. In the example, the analysis of the driving safety degree is performed in this aspect.

Back in FIG. 1, the camera 104 is one specific example of the “image obtaining device” in the structure example of the present invention. The camera 104 is typically provided to take a vehicle front image. The image taken by the camera 104 is analyzed on the image analysis part 105; for example, the features of scenery in the vehicle front image data are analyzed by the method described in the patent document 2. The analyzed scenery feature data is treated as the time-series data of the scenery outside the vehicle on the image analysis part 105, so that it is held for a predetermined time. Alternatively, the acceleration data is stored in the information recording part 109 described later.

The road analysis part 106 is one specific example of the “road analyzing device” in the structure example of the present invention. The road analysis part 106 numerically analyzes the complexity of the scenery of a road, or the complexity of a road shape, as a road complexity degree in the time-series data of the scenery of the road held. More specifically, the scenery outside the vehicle is classified on the basis of the analyzed scenery feature data of the scenery image of the road, and the value of the road complexity degree is increased or reduced on the basis of the classification. In this aspect, for example, a flat, open road such as an expressway, is judged to be a “simple road”, whereas a street, a forest road, an avenue, or the like is judged to be a “complicated road”. The image of the scenery outside the vehicle is classified into the “simple road” and the “complicated road” when the scenery feature satisfies predetermined conditions, and it is classified as “others” if the scenery feature satisfies neither of these two conditions.

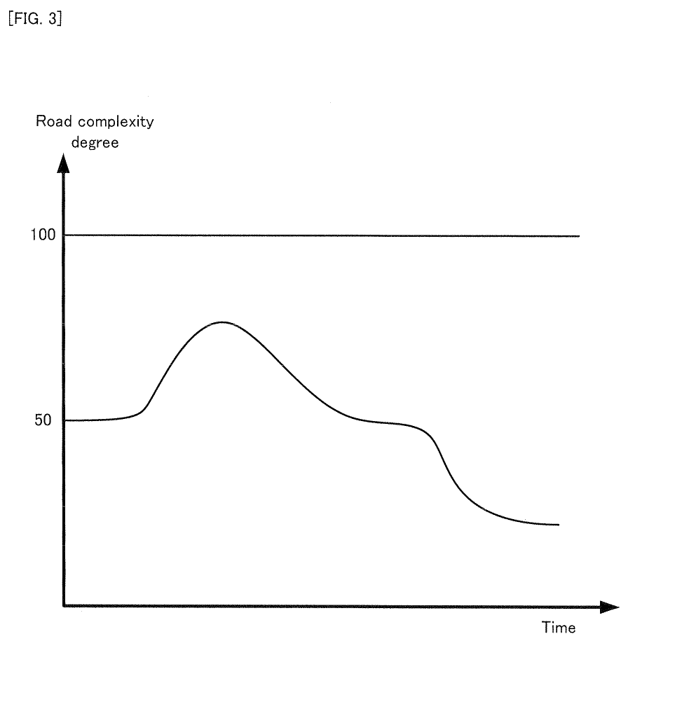

Here, FIG. 3 is a graph showing the value of the road complexity degree calculated on the road analysis part 106, showing one example of the time-series data of the road complexity degree BN starting from BN=50, wherein the horizontal axis indicates time and the vertical axis indicates the road complexity degree BN. At this time, the road complexity degree BN is expressed as BN=B(N−1)+S(N>0). The range of the road complexity degree BN is set to be 0 to 100, and a value remains within the range when it goes out of the range (e.g. 0 is set as the lower limit and 100 as the upper limit). At this time, as the road complexity degree BN gets closer to 0, the conditions of the road on which the vehicle travels are judged to be simpler, and as the road complexity degree BN gets closer to 100, the road conditions are judged to be more complicated. Here, S is a predetermined numerical value defined as a road complexity degree index, and the S value is reduced (e.g. S−1) when the judgment is the aforementioned “simple road”. On the other hand, the S value is added (e.g. S+1) when the judgment is the “complicated road”. Moreover, if it is classified as the “others” other than the “simple road” and the “complicated road”, the S value does not change.

As shown in FIG. 3, the vehicle starting from the road complexity degree BN=50 is in motion on a road classified as the “others” at the beginning, and the graph does not rise nor descend. Moreover, if the vehicle is in motion on the complicated road, such as a street, the road complexity degree BN starts to increase, and if the vehicle continues to travel on the open road which is the “simple road” having some roads classified as the “others”, the graph gradually descends.

The travel situation operation part 107 operates an emotion felt by a virtual personality based on the assumption that the vehicle has the personality or the assumption that a vehicle occupant has the personality or the like, in accordance with the vehicle travel situation on the basis of the analysis results of the driving analysis part 103 and the road analysis part 106.

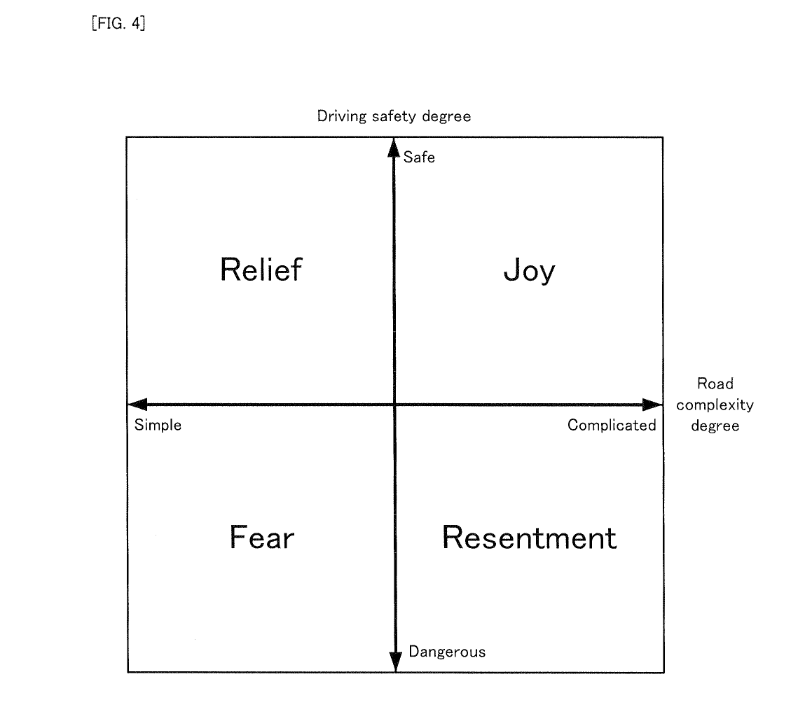

As shown in FIG. 4 to FIG. 7, the analysis results are plotted on the two-axis graph, with the driving safety degree analysis result on the vertical axis and with the road complexity degree analysis result on the horizontal axis. Here, the calculation of the emotion is performed by outputting the emotions set in accordance with a predetermined area (four emotions of “joy”, “relief”, “fear”, and “resentment” in the graph in FIG. 4) if the values of the driving safety degree AN and the road complexity degree BN are in the predetermined area. Incidentally, in the example, the above four words are shown as emotion examples; however, the emotions are not limited to these examples, and other words such as “pleased”, “relaxed”, “anger”, “impatient” and the like may be used. More specifically, if the evaluation for the driver's driving by the driving safety degree AN is judged to be relatively safe, an emotion of enjoying driving (i.e. joy, relief, or the like) is correspondingly assigned. On the contrary, if the driving is judged to be dangerous, an emotion such as fear, an anger to the driver, or the like (i.e. fear, resentment, or the like) is assigned. On the other hand, if the analysis result of the road conditions by the road complexity degree BN provides relatively complicated road scenery, an emotion to an object outside the vehicle (i.e. joy, resentment, or the like) is assigned. On the contrary, in simple road scenery, an emotion to oneself (i.e. relief, fear, or the like) is assigned.

By combining the emotion assigned on the basis of the driving safety degree AN and the emotion assigned on the basis of the road complexity degree BN (i.e. in accordance with mapping on the two-axis graph), it is possible to output the emotion according to a situation inside the vehicle (i.e. the aspect of the driving by the driver) and a situation outside the vehicle (i.e. the complexity of the road scenery outside the vehicle). One example of the aspect of the output of the emotion based on such evaluation will be explained. For example, in the travel situation with the high driving safety degree AN and the high road complexity degree BN, it is estimated that it is safe driving and that the vehicle occupant can afford to enjoy the scenery outside the vehicle, and the emotion of “joy” is outputted. On the other hand, in the travel situation with the high road complexity degree BN but with the relatively low driving safety degree AN because of the “dangerous driving” such as sudden acceleration of the vehicle (as one specific example, if the “dangerous driving” is performed in the “complicated road” such as an urban area), the “resentment” to the driver or an emotion of calling the driver's attention is outputted. Moreover, in the travel situation with the relatively low road complexity degree BN, such as when the road on which the vehicle travels is the “simple road” like the expressway, and with the high driving safety degree AN because of the driver's safe driving, an interest in the external world drops off with the relief, and the emotion of “relief” such as sleeping and having a conversation with the occupant is outputted. On the other hand, if the “dangerous driving” with the relatively low driving safety degree AN is performed in the situation that the vehicle is in motion on the “simple road”, the emotion of “fear” such as being frightened or scared of an accident is outputted.

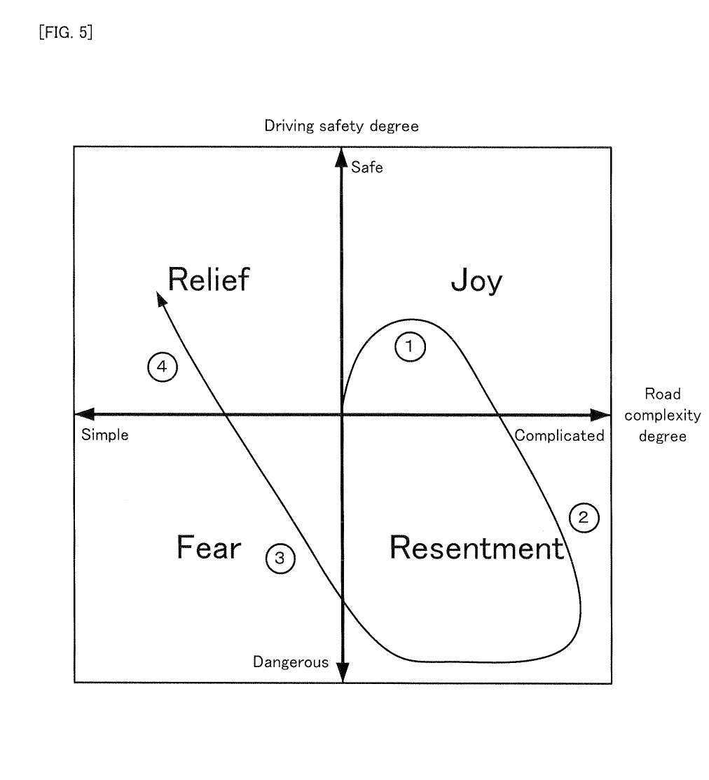

FIG. 5 shows that the time-series data of the travel situation of the vehicle in motion under a certain condition is plotted on the graph in FIG. 4 in the construction that the corresponding emotion is outputted by the driving safety degree AN and the road complexity degree BN. In other words, it is one specific example showing the evaluation result of the vehicle travel situation. In FIG. 5, the vehicle starts from a condition with the driving safety degree of 50 and the road complexity degree BN of 50 (i.e. the central point of the graph in FIG. 5). Firstly, in the situation that the vehicle passes through a “street” (i.e. a road with the more-or-less higher road complexity degree BN) from a road in which the road scenery is classified to the “others”, since the driver performs the safe driving, it is estimated that the vehicle occupant can afford to enjoy the scenery outside the vehicle, and the emotion of “joy” is outputted (1 in FIG. 5). Then, the “dangerous driving”, such as continuous sudden braking by the driver, reduces the driving safety degree AN. In the travel situation, for example, the “resentment” to the driver who performs the “dangerous driving” on the “complicated road” such as an urban area or the emotion of calling the driver's attention is outputted (2 in FIG. 5). Then, the vehicle comes to travel on the “street” gradually to the “open road” (i.e. the “simple road” with the relatively low road complexity degree), and the emotion of “fear” such as being frightened or scared of an accident is outputted to the “dangerous driving” on such a road (3 in FIG. 5). Then, with a gradual increase in the driver's driving safety degree AN in the “simple road”, an interest in the external world drops off, and the emotion of “relief” such as sleeping, enjoying a conversation, and thinking about something is outputted (4 in FIG. 5).

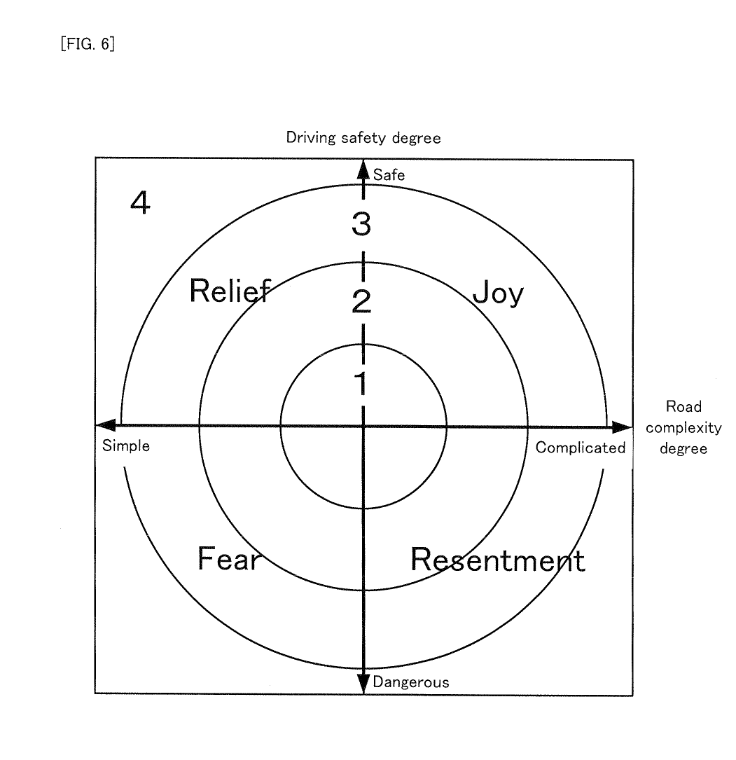

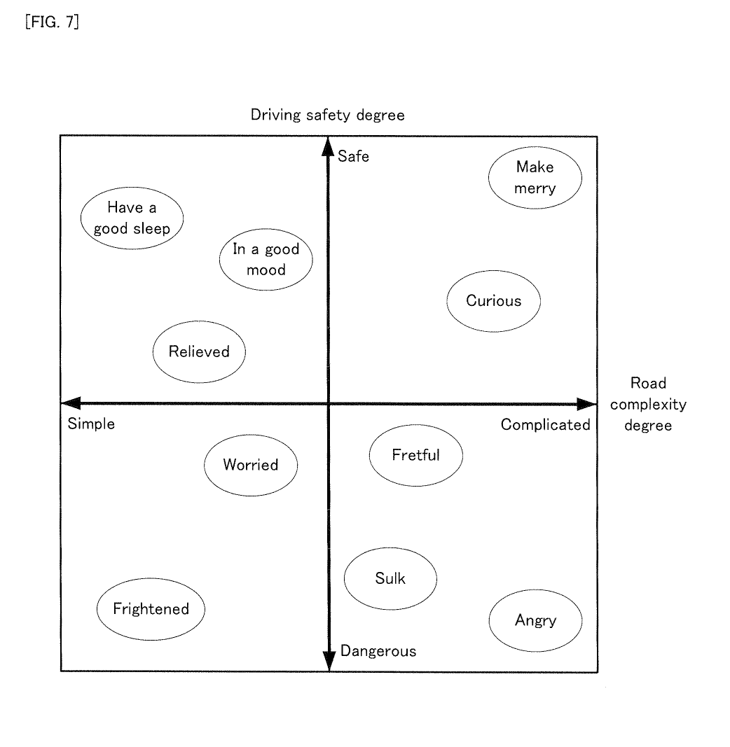

Moreover, the emotion outputted from the travel situation operation part 107 may be not the four ways of “joy”, “relief”, “fear”, and “integration” as shown in FIG. 4, but it may be constructed such that each emotion level rises with distant from the origin of the graph with its origin in the case of the driving safe degree AN and the road complexity degree BN of 50 as shown in FIG. 6. Moreover, as shown in FIG. 7, the emotion may be constructed by using an emotion map with more detailed emotions divided on the basis of the values of the driving safe degree AN and the road complexity degree BN. FIG. 7 shows one example of the emotion map.

The emotion map may be constructed to perform predetermined output other than the output of the emotion in accordance with the values of the driving safe degree AN and the road complexity degree BN analyzed. As one example of such construction, an event according to the area is triggered in accordance with a change in values in a predetermined area.

Moreover, the emotion map may be constructed to change the placement, type, or occurrence frequency of the emotion map by storing data about the frequency of the event trigger, the driver's driving habit, the individual character of a robot described later, or the like in the information recording part 109 and by using the stored data.

The information output part 108 is one specific example of the “outputting device” in the structure example of the present invention. The information output part 108 announces the emotion operated on the travel situation operation part 107 to the vehicle occupant including the driver, and it may be, for example, a display, a speaker, a robot which performs operations according to the emotion, or the like. The announcement on the information output part 108 may be performed in various modes, such as by character or text information and image information for displaying the operated emotion on the display, by music and audio through a speaker, by the operations of the robot, to the vehicle occupant, or only to the driver. It is considered that the announcement allows the driver to indirectly know, for example, the occupant's emotion, and the announcement can provide the basis for the decision of a driving guideline: trying safer driving if the emotion of “resentment” is outputted, and enjoying a conversation in the case of the emotion of “relief”.

Incidentally, the aspect of the announcement by the operations of the robot is performed by the operations of the robot which corresponds to each emotion outputted by the travel situation operation part 107 (i.e. which can preferably express each emotion). For example, the announcement may be performed with an operation that causes at least the driver and the occupant of the vehicle that receives such announcement to have the emotion of “relief”, “fear”, or the like described above. Moreover, as one example of the individual characteristics of the robots described above, in case of the robots which has different modes of the action corresponding to respective emotions each other and had various pattern of individual characteristics, each of the robot acts in different modes even if they perform the announcement corresponding to the same emotion in the same condition (although the emotion that can be caused, which is at least the origin of the output, is the same).

The information recording part 109 is typically a memory and stores the detection result, the analysis result, or the operation result on each part, in conjunction with each of the acceleration sensor 101, the sensor input part 102, the driving analysis part 103, the camera 104, the image analysis part 105, the road analysis part 106, the travel situation operation part 107, and the information output part 108. Moreover, in conjunction with the aspect of the operation or analysis on each part, the stored data is outputted.

As a result, according to this structure example, it is possible to announce the evaluation result of the vehicle travel situation operated on the basis of the driver's driving safety and the road complexity degree of the road on which the vehicle travels, to the vehicle occupant, in a form of the emotion of the virtual personality, same as the structure example explained above.

### (2) Basic Operation

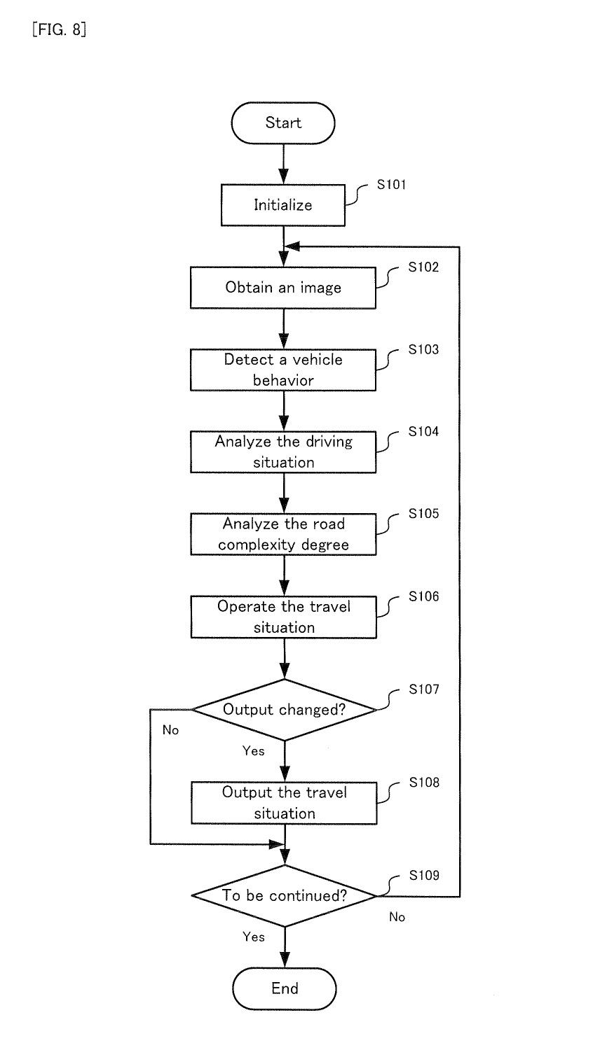

Next, with reference to FIG. 8, an explanation will be given on the basic structure associated with the evaluation for the vehicle travel situation by the driving evaluation apparatus 1 in the example.

As shown in FIG. 8, firstly, each part is initialized (step S101). In this operation, the acceleration sensor 101 is initialized, and the detection of the acceleration is newly started. At the same time, the transmission of the detected acceleration data to the sensor input part 102 is started. The time-series data of the acceleration held on the sensor input part 102 is also initialized. Moreover, shooting with the camera 104 is started, and the transmission of the taken image to the video analysis part 105 is started. Moreover, the time-series data of the road scenery held on the image analysis part 105 is initialized.

Even in each of the driving analysis part 103, the road analysis part 106, and the travel situation operation part 107, the data is initialized. Firstly, in each part, the time-series data number is set to N=0. Then, the driving danger index K in the driving analysis part 103 is set to K=1 in the initialization, and the driving safety degree AN (i.e. the driving safety degree A0) is set to AN=50. On the other hand, the road complexity degree index S in the road analysis part is set to S=0 in the initialization, and the road complexity degree BN (i.e. the road complexity degree B0) is set to BN=50.

Then (to be precise, always after the initialization (step S101)), taking a vehicle front image (step S102) and the detection of the vehicle acceleration (step S103) are performed. The scenery image taken by the camera 104 is transmitted to the image analysis part 105, and it is stored as the time-series data of the image on the image analysis part 105 or the information recording part 109. The acceleration detected on the acceleration sensor 101 is transmitted to the sensor input part 102, and it is stored as the time-series data of the acceleration on the sensor input part 102 or the information recording part 109. At this time, each time-series data is stored at least in a predetermined period (e.g. for the past five minutes) to be used for the analysis described later. Such an aspect of the detection is preferably always performed during the vehicle motion (at least while the driving evaluation apparatus 1 is running) and may be an arbitrary aspect without being particularly limited to the order for convenience shown in FIG. 8.

Then, from the time-series data of the scenery image and the time-series data of the acceleration stored in the information memory part, each of the operation of the driving safety degree AN (step S104) and the operation of the road complexity degree BN (step S105) is performed.

Specifically, the driving safety degree AN is analyzed in a predetermined period or in predetermined timing, on the driving analysis part 103 on the basis of the time-series data of the acceleration stored in the sensor input part 102 or the information recording part 109. On the other hand, the road complexity degree BN is analyzed in a predetermined period or in predetermined timing, on the driving analysis part 103 on the basis of the time-series data of the acceleration stored in the image analysis part 105 or the information recording part 109. The analyzed driving safety degree AN and road complexity degree BN are transmitted to the travel situation operation part 107. Such an aspect of the analysis is preferably always performed in a predetermined period or in predetermined timing during the vehicle motion (at least while the driving evaluation apparatus 1 is running) and may be an arbitrary aspect without being particularly limited to the order for convenience described in FIG. 8.

In response to the input of the analysis results of the driving safety degree AN and the road complexity degree BN, the emotion according to the vehicle travel situation is operated (step S106). The operated emotion is outputted through the information output part 108 in an output step described later (step S108). At this time, typically, the output of the emotion is continued as long as the same emotion is continuously operated. In other words, in the operation in the step S106, it is judged whether or not there is a change in the operated emotion (step S107).

If there is a change in the operated emotion (the step S107: Yes), the newly operated emotion is outputted (the step S108). On the other hand, if there is no change in the operated emotion (the step S107: No), the newly operated emotion is not outputted (i.e. the output of the emotion of the previous operation result is continued).

Then, if the operation of the driving evaluation apparatus 1 is continued (step S109), a flow of a series of operations (i.e. the operations in the step S102 to the step S108) is repeated. On the other hand, if the operation of the driving evaluation apparatus 1 is stopped by a user's operation or for some reasons (the step S109: No), the flow of operations is ended.

### (3) Modified Example

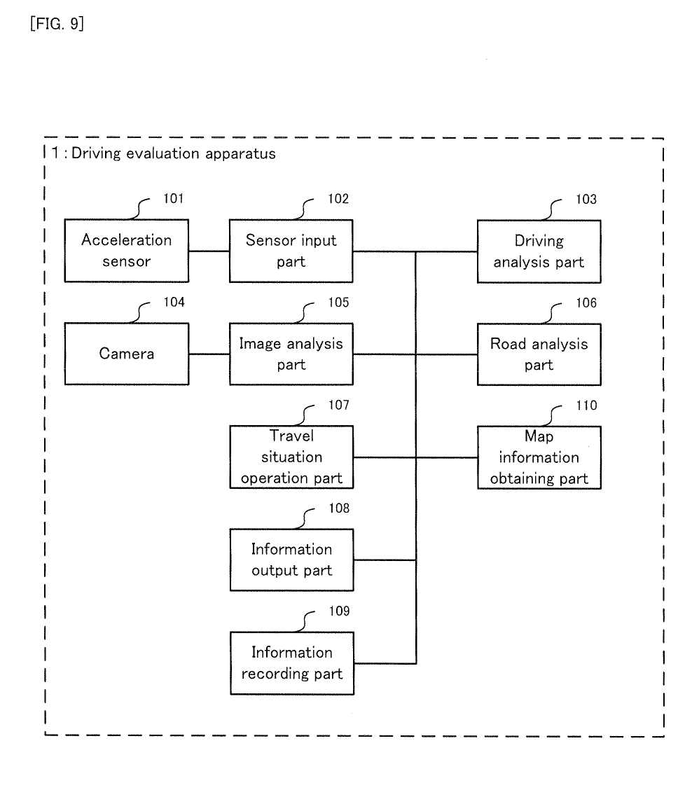

A modified example of the vehicle driving evaluation apparatus in the example of the present invention will be explained with reference to FIG. 9. FIG. 9 is a block diagram conceptually showing the basic structure of the vehicle driving evaluation apparatus in the modified example. Incidentally, the same constituents as those shown in the other drawings carry the same numerical references.

In the aforementioned structure example, the image of the scenery outside the vehicle obtained by the camera 104 is analyzed in the image analysis part 105, on the characteristics of the scenery. On the basis of the analysis result, the road analysis part 106 classifies the scenery outside the vehicle and operates the road complexity degree BN.

On the other hand, in the modified example, as shown in FIG. 9, there is provided a map information obtaining part 110 which is one specific example of the “map information obtaining device” of the present invention. By analyzing map information (typically, map information using GPS or the like) about the surroundings of the vehicle obtained by the operation of the map information obtaining part 110, map information is obtained, such as the scenery around the vehicle, and the shape and slope of a road on which the vehicle travels. The road analysis part 106 performs the operation on the basis of road information, or on the basis of the road information in combination with the aforementioned analysis result of the scenery image, thereby calculating the road complexity degree BN. Incidentally, the map information obtaining part 110 is a navigation apparatus for obtaining the aforementioned map information by communication with the exterior, or the like.

Moreover, in the modified example, in the analysis of the image of the scenery outside the vehicle on the aforementioned image analysis part 105, not only the features of the scenery outside the vehicle but also an obstacle for the vehicle to travel, such as a vehicle and a person around the vehicle provided with the driving evaluation apparatus 1, are detected. In such construction, the road analysis part 106 performs the operation on the basis of its obstacle information or on the basis of the obstacle information in combination with the analysis result of the scenery image and the road information described above, thereby calculating the road complexity degree BN.

The aspect of the operation of the road complexity degree BN on the road analysis part 106 in the modified example is performed by an arbitrary combination of the road complexity degree index determined by each of (1) the road conditions classified by the analysis of the scenery image (i.e. the classification to the “simple road”, the “complicated road”, and the “others”), (2) the number of obstacles around the vehicle detected by the analysis of the scenery image, or the like, and (3) the road information about the shape, slope, or the like of the road on which the vehicle travels, obtained by the analysis of the map information by the map information obtaining part 110. In other words, by using a road complexity degree index SA analyzed from the scenery image, a road complexity degree index SB analyzed from the obstacle information, and a road complexity degree index SC analyzed from the map information, the road complexity degree BN is expressed as BN=B(N−1)+SA+SB+SC(N>0). Incidentally, as described above, the road complexity degree BN may be determined by an arbitrary combination of SA, SB, and SC, and the aspect of calculation of the road complexity degree BN described above may be constructed from at least one of SA, SB, and SC. Incidentally, the road complexity degree index SA analyzed from the scenery image in the modified example is defined as the same numerical value as the road complexity degree index S in the structure example.

The road complexity degree index SB analyzed from the obstacle information in the modified example is defined as a predetermined numerical value to be added or subtracted, from the judgment based on the number of the obstacles around the vehicle detected in the above manner. For example, if it is judged that the number of the obstacles detected around the vehicle is less than or equal to a predetermined threshold value, the number of SB is subtracted (e.g. SB−1). On the other hand, if it is judged that the number of the obstacles detected around the vehicle is greater than or equal to the predetermined threshold value, the number of SB is added (e.g. SB+1). Alternatively, if the number is in a predetermined range, the addition and the subtraction are not performed.

The road complexity degree index SC analyzed from the road information in the modified example is defined as a predetermined numerical value to be added or subtracted, from the judgment based on the road information such as the shape and slope of the road on which the vehicle travels, obtained in the above manner. For example, if it is judged that the shape of the road on which the vehicle travels is complicated for the vehicle travel, such as a continuous sharp bend and a steep slope, the value of SC is added (e.g. SC+1). On the other hand, if it is judged that the shape does not have such a complicated shape but have a relatively simple road shape, the value of SC is subtracted (e.g. SC−1).

The other constituents are the same as those described in the structure example.

As a result, according to the modified example, as in the structure example, it is possible to announce the evaluation result of the vehicle travel situation operated on the basis of the driver's driving safety and the road complexity degree of the road on which the vehicle travels, to the vehicle occupant, in a form of the emotion of the virtual personality. Incidentally, according to the modified example, it is possible to improve the accuracy of the road complexity degree to be operated, by combining a plurality of road complexity degree indexes in the operation of the road complexity degree.

The present invention is not limited to the aforementioned example, but various changes may be made, if desired, without departing from the essence or spirit of the invention which can be read from the claims and the entire specification. A vehicle driving evaluation apparatus and method, and a computer program, all of which involve such changes, are also intended to be within the technical scope of the present invention.

1. A vehicle driving evaluating apparatus comprising:
a behavior detecting device for detecting a behavior of a vehicle a driver is driving;
a driving analyzing device for analyzing an aspect of driving of the driver on the basis of the behavior of the vehicle;
a road analyzing device for analyzing condition of a road on which the vehicle is in motion;
a travel situation evaluating device for evaluating a travel situation of the vehicle on the basis of the aspect of the driving of the driver and the conditions of the road on which the vehicle is in motion;
an image obtaining device for obtaining an image of scenery around the vehicle;
an obstacle detecting device for detecting information about an obstacle for the vehicle to travel; and
map information obtaining device for obtaining map information around the vehicle,
said road analyzing device analyzing a complexity degree of the road as the condition of the road on which the vehicle is in motion.

2. The vehicle driving evaluating apparatus according to claim 1, wherein said travel situation evaluating device classifies the travel situation of the vehicle into a plurality of ways for the evaluation, on the basis of at least two-axis graph information with each of the aspect of the driving of the driver and the conditions of the road on which the vehicle is in motion on the axis.

3. The vehicle driving evaluating apparatus according to claim 2, wherein
said driving analyzing device analyzes a driving safety degree as a parameter based on the aspect of the driving, and
said road analyzing device analyzes a complexity degree of the road as the conditions of the road on which the vehicle is in motion.

4. The vehicle driving evaluating apparatus according to claim 3, further comprising an outputting device for performing an output based on an evaluation result of the travel situation of the vehicle.

5. The vehicle driving evaluating apparatus according to claim 4, wherein each of a plurality of types of emotions owned by a virtual personality is assigned in association with respective one of the travel situations classified in the plurality of ways, and said outputting device outputs at least one emotion from the plurality of emotions.

6. (canceled)

7. (canceled)

8. A computer program product in a computer-readable medium for tangibly embodying a program of instructions executable by a computer provided in a vehicle driving evaluating apparatus comprising: a behavior detecting device for detecting a behavior of a vehicle a driver is driving; a driving analyzing device for analyzing an aspect of driving of the driver on the basis of the behavior of the vehicle; a road analyzing device for analyzing condition of a road on which the vehicle is in motion; a travel situation evaluating device for evaluating a travel situation of the vehicle on the basis of the aspect of the driving of the driver and the conditions of the road on which the vehicle is in motion; an image obtaining device for obtaining an image of scenery around the vehicle; an obstacle detecting device for detecting information about an obstacle for the vehicle to travel; and map information obtaining device for obtaining map information around the vehicle, said road analyzing device analyzing a complexity degree of the road as the condition of the road on which the vehicle is in motion.
said computer program making the computer function as at least one portion of said behavior detecting device, said driving analyzing device, said road analyzing device, and said travel situation evaluating device.

9. A vehicle driving evaluating method comprising:
a behavior detecting process of detecting a behavior of a vehicle a driver is driving;
a driving analyzing process of analyzing an aspect of driving of the driver on the basis of the behavior of the vehicle;
a road analyzing process of analyzing condition of a road on which the vehicle is in motion;
a travel situation evaluating process of evaluating a travel situation of the vehicle on the basis of the aspect of the driving of the driver and the conditions of the road on which the vehicle is in motion;
an image obtaining process of obtaining an image of scenery around the vehicle;
an obstacle detecting process of detecting information about an obstacle for the vehicle to travel; and
map information obtaining process of obtaining map information around the vehicle,
said road analyzing process analyzing a complexity degree of the road as the condition of the road on which the vehicle is in motion.
